(19) United States
(12) Patent Application Publication
(10) Pub. No.: US 2009/0160610 A1
(43) Pub. Date: Jun. 25, 2009

(54) PSEUDORANDOM NUMBER GENERATOR

(76) Inventors: KRISHNA S. DODDAMANE, Allen, TX (US); Steven C. Lazar, McKinney, TX (US)

Correspondence Address: TEXAS INSTRUMENTS INCORPORATED, P O BOX 655474, M/S 3999, DALLAS, TX, 75265, US

(21) Appl. No.: 11/959,740

(22) Filed: Dec. 19, 2007

(51) Int. Cl. H04Q 5/22; G06F 7/58

(52) U.S. Cl. 340/10.1; 708/250

(57) ABSTRACT

One embodiment of the invention includes a pseudorandom number generator (PRNG) for generating pseudorandom numbers for a radio frequency identification (RFID) tag. The PRNG includes an analog portion configured to generate a pseudorandom number seed having a value that varies based on sampling a received RF signal. A digital portion is configured to generate a pseudorandom number based on the pseudorandom number seed generated by the analog portion.

### TECHNICAL FIELD

This invention relates to electronic circuits, and more specifically to a pseudorandom number generator.

### BACKGROUND

Radio frequency identification (RFID) has become an increasingly important technology with a variety of applications, such as security and inventory. In a typical RFID system, an RFID reader continuously emits an RF interrogation signal. An RFID tag (or transponder) that is within vicinity can receive the RF interrogation signal using an RF antenna. The received RFID interrogation signal can be processed within an integrated circuit (IC) within the RFID tag, and the RFID tag can transmit a response signal via the RF antenna to the RFID reader. The response signal can include identification information about the RFID tag, such as based on a unique code. In a passive RFID tag, the processing and the generation of the response signal can be powered by storing and releasing the energy of the received RFID interrogation signal. As a result, passive RFID tags can be manufactured without an active power source, thus permitting the manufacture of RFID tags with a small form-factor.

Some RFID tags can include a pseudorandom number generator (PRNG) to generate pseudorandom numbers that are implemented for a variety purposes. As an example, an RFID reader that transmits an RFID interrogation signal to multiple RFID tags may need to be able to distinguish the RF response signals from each other. Thus, each of the RFID tags may employ a pseudorandom number as part of the respective RF response signals. For instance, an RFID tag can use a pseudorandom number as a key for encryption, when transmitting its own information. Additionally, or alternatively, the pseudorandom can be utilized in timing the response signal to mitigate collisions between responses generated at two or more separate RFID tags.

### SUMMARY

One embodiment of the invention includes a pseudorandom number generator (PRNG) for generating pseudorandom numbers for a radio frequency identification (RFID) tag. The PRNG includes an analog portion configured to generate a pseudorandom number seed having a value that varies based on sampling a received RF signal. A digital portion is configured to generate a pseudorandom number based on the pseudorandom number seed generated by the analog portion.

Another embodiment of the invention includes a method of generating pseudorandom numbers within a passive RFID tag. The method includes receiving a radio frequency (RF) signal via an antenna and providing a first analog clock signal based on detecting analog RF signal corresponding to the received RF signal. A second analog clock signal is generated by an oscillator that is powered in response to the RF signal, the second analog clock signal having a frequency that is less than a frequency of the first clock signal. The first analog clock signal is sampled according to the second analog clock signal to generate a pseudorandom number seed. Digital logic operations are performed on the pseudorandom number seed to generate a pseudorandom number.

Another embodiment of the invention includes an RFID tag. The RFID tag includes means for receiving an RFID interrogation signal. The RFID tag also includes means for generating a pseudorandom number seed having a value that varies based on sampling an analog signal derived from the received RFID interrogation signal. The RFID tag also includes means for generating a pseudorandom number by performing digital logic operations on the pseudorandom number seed.

### BRIEF DESCRIPTION OF THE DRAWINGS

FIG. 1 illustrates an example of a radio frequency identification (RFID) system in accordance with an aspect of the invention.

FIG. 2 illustrates an example of an RFID tag in accordance with an aspect of the invention.

FIG. 3 illustrates an example of a pseudorandom number generator (PRNG) in accordance with an aspect of the invention.

FIG. 4 illustrates an example of a method for generating a pseudorandom number in accordance with an aspect of the invention.

### DETAILED DESCRIPTION

The invention relates to electronic circuits, and more specifically to a pseudorandom number generator (PRNG). The PRNG can be implemented in an RFID tag (or transponder), such that the pseudorandom number can be generated and utilized in connection with an RF response signal from the RFID tag. The PRNG can include an analog portion and a digital portion. The analog portion can include a gate that obtains samples of an RF signal (e.g., a received RFID interrogation signal) according to an analog clock signal generated from an oscillator. The oscillator can be intentionally configured to be unstable or in accurate, such as by utilizing inexpensive components, thus providing an additional randomness to the generation of the pseudorandom numbers. The samples of the RF signal can be multi-bit, and can be provided to a buffer that shifts the samples into a linear feedback shift register (LFSR) residing in a digital portion of the PRNG. Thus, the digital samples of the RF signal are used to generate a seed for the LFSR. The LFSR therefore digitally generates a pseudorandom number from the seed. As a result, the PRNG combines the benefits of analog and digital pseudorandom number generation, such that a seed for the LFSR is pseudorandomly generated in an analog manner for the digital generation of a resultant pseudorandom number.

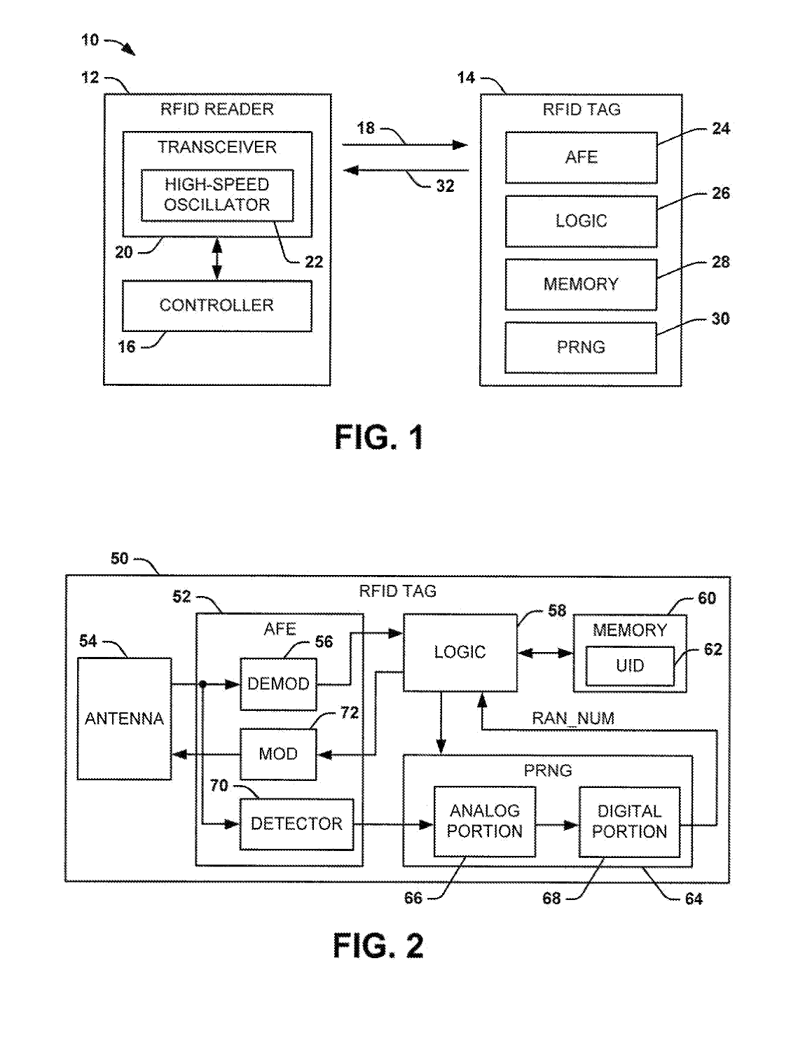

FIG. 1 illustrates an example of a radio frequency identification (RFID) system 10 in accordance with an aspect of the invention. The RFID system 10 can be utilized in any of a variety of applications, such as inventory management, commerce, and security. The RFID system 10 includes an RFID reader 12 and an RFID tag 14. The RFID reader 12 includes a controller 16 that is configured to generate RFID interrogation signals, demonstrated in the example of FIG. 1 at 18, via a transceiver 20. As an example, the RFID interrogation signals 18 can be circularly-polarized and can be transmitted at any of a variety of frequencies across the RFID spectrum (i.e., 860-960 MHz). In the example of FIG. 1, the transceiver 20 includes a high-speed oscillator 22 that is configured to generate a carrier frequency for the RFID interrogation signals 18.

The RFID tag 14 can be configured as a passive RFID tag, and can thus be configured without a dedicated power source, such as a battery. In the example of FIG. 1, the RFID tag 14 includes an analog front-end (AFE) 24. The AFE 24 includes an antenna and modulation/demodulation components (not shown) for receiving and transmitting RF signals. Specifically, upon the RFID tag 14 being within sufficient proximity in the far-field of the transmitted RFID interrogation signal 18, the AFE 24 receives a sufficient amount of RF energy to receive and process the RFID interrogation signal 18. The RF energy is stored within one or more electronic power storage devices (not shown), such as including one or more capacitor. The stored energy is thus implemented to power a logic component 26, which can process the demodulated RFID interrogation signal 18 and generate a response.

As an example, the logic component 26 can access a memory 28 to obtain a unique identification code (UID), which can be modulated into the response. In addition, in the example of FIG. 1, the RFID tag 14 includes a pseudorandom number generator (PRNG) 30 that is configured to generate a pseudorandom number upon the RFID tag 14 receiving power, such as based on the received RF energy from the RFID interrogation signal 18. The pseudorandom number can likewise be modulated into the response that is generated by the logic component 26. As an example, the pseudorandom number can be implemented to avoid collisions between multiple RFID tags, including the RFID tag 14, that are concurrently in the far-field of the RFID interrogation signal 18. It is to be understood, however, that the pseudorandom number can be generated for any of a variety of other reasons, as well.

The PRNG 30 can be configured to generate the pseudorandom number based on processing performed in both the analog domain and the digital domain. As an example, the PRNG 30 can include an analog portion configured to generate a first pseudorandom number based on sampling a high-frequency RF signal, such as an analog signal derived from the RFID interrogation signal 18. Specifically, the carrier frequency of the RFID interrogation signal 18, such as provided by the high-speed oscillator 22 included in the RFID reader 12, can be detected from the RFID interrogation signal. The corresponding signal can be sampled according to a sampling frequency that is lower than the frequency signal derived from the RFID interrogation signal. The sampling frequency can be provided by a clock signal provided by an analog oscillator, such as may be powered internally from the received RFID signal. The resulting samples can be stored or buffered as to generate a seed having a value that varies based on received RFID signal and the sampling frequency the generation of the pseudorandom number. The seed can then be provided to a digital portion of the PRNG 30 that is configured to perform digital logic operations, such as via an LFSR, on the seed to generate the resultant pseudorandom number. As a result, the PRNG 30 can generate the pseudorandom number in a less predictable manner by generating a seed in an analog manner and generating the pseudorandom number from the seed in a less power intensive digital manner.

Upon generating the response, the logic component 26 provides the response to the AFE 24, which is thus configured to modulate the response for transmission. As a result, the RFID tag 14 transmits an RF response signal 32 back to the RFID reader 12. The RFID reader 12 can thus receive and demodulate the RF response signal 32 at the transceiver 20. The information that is contained within the response is thus provided to the controller 16. For example, the controller 16 can verify a UID to allow or deny access to a secured region, can increment or decrement inventory counters, and/or can provide a monetary transaction. Furthermore, the controller 16 can also receive a pseudorandom number as part of the response (e.g., for encryption or identification purposes). such that the controller 16 can distinguish the RFID tag 14 from other RFID tags that likewise received the RFID interrogation signal 18. Alternatively or additionally, the pseudorandom number can be employed by the logic 26 or other control circuitry in the RFID tag 14 to control the timing when the RF response signal 32 is transmitted.

It is to be understood that the RFID system 10 is not intended to be limited to the example of FIG. 1. Specifically, the RFID system 10 is demonstrated in the example of FIG. 1 in a simplistic manner for the sake of brevity of explanation. As such, the RFID reader 12 and the RFID tag 14 can each include any of a variety of additional components that are not demonstrated in the example of FIG. 1.

FIG. 2 illustrates an example of an RFID tag 50 in accordance with an aspect of the invention. The RFID tag 14 in the example of FIG. 1 can be configured substantially the same as the RFID tag 50. As such, reference may be made back to the example of FIG. 1 to understand an example context shown for the RFID tag 50.

The RFID tag 50 includes an AFE 52. The AFE 52 includes an antenna 54 configured to receive RFID interrogation signals and to transmit RF response signals in response to the RFID interrogation signals. Because the RFID tag 50 can be configured as a passive RFID tag, the energy from a received RFID interrogation signal can be provided to a power storage device (not shown) to provide power to the RFID tag 50. In addition, the received RFID interrogation signal is provided to a demodulator 56 that is configured to demodulate the received RFID interrogation signal. The demodulated RFID interrogation signal is then provided to a logic component 58 that is configured to process the RFID interrogation signal.

In response to receiving the RFID interrogation signal, the logic component 58 can access a memory 60 to obtain a UID 62 that is stored within the memory 60. In addition, the logic component 58 can provide a request to a PRNG 64 to generate a pseudorandom number, demonstrated in the example of FIG. 2 as RAN_NUM. The PRNG 64 includes an analog portion 66 and a digital portion 68. The analog portion 66 receives a high-speed analog signal as an input from a detector 70. In the example of FIG. 2, the detector 70 is provided with the RFID interrogation signal as an input. The detector 70 can be configured to generate an analog clock signal having a frequency that is commensurate with the frequency of the carrier signal of the RFID interrogation signal. For example, the detector 70 can be implemented as including a rectifier (e.g., a half-wave rectifier, such as a diode) or other circuitry configured to generate an output clock a frequency that is greater than a sampling frequency employed to sample such clock signal. The detector 70 can be implemented as part of the AFE 52, such as depicted in FIG. 2, or the detector can be separately implemented as part of the analog portion 66 of the PRNG 64.

As a further example, the analog portion 66 can include an oscillator that provides a sampling clock signal at a sampling frequency to obtain samples of the detector output signal. For instance, the samples can be obtained at each cycle of an analog signal that is generated by the oscillator. The oscillator can have a frequency that is substantially less than analog signal provided from the detector 70, and the digital samples that are generated can be provided at a specific, desired resolution. For example, the digital samples can be single-bit samples or can be multi-bit samples (e.g., two-bits, three-bits or more). The digital samples can thus form a pseudorandom number seed that is provided to the digital portion 68. The digital portion 68 can therefore digitally generate the pseudorandom number RAN_NUM based on the pseudorandom number seed. As an example, the digital portion 68 can include an LFSR that is shifted based on stimulus from the logic component 58, or from a dedicated oscillator or logic state-machine of the RFID tag 50.

Upon receiving the UID 62 and the pseudorandom number RAN_NUM, the logic component 58 can generate a response to the RFID interrogation signal. The response can include both the UID 62. The response may also include or be encrypted based on the pseudorandom number RAN_NUM, as well as any of a variety of additional information. The response is provided to a modulator 72 that is configured to modulate the response as an RF response signal which is transmitted from the RFID tag 50 via the antenna 54. The timing of the response signal being transmitted from the RFID tag 50 also may vary as a function of the pseudorandom number RAN_NUM. As a result, the associated RFID reader can receive the RF response signal and process it appropriately, such as described above in the example of FIG. 1.

It is to be understood that the RFID tag 50 is not limited to the example of FIG. 2. As an example, although demonstrated separately, multiple components of the RFID tag 50 can be integrated together to form a single integrated circuit (IC). As an example, the RFID tag 50 can include an IC and the antenna 54, such that the IC includes the logic component 58, the PRNG 64, the memory 60, and the remaining components of the AFE 52. As another example, although the detector 70 is demonstrated in the example of FIG. 2 as being a dedicated component, it is to be understood that the detector 70 could be part of the demodulator 56. As such, the detector 70 could be implemented both for demodulation and for providing a high-frequency analog signal (i.e., the carrier of the RFID interrogation signal) to the analog portion 66 of the PRNG 64. Furthermore, additional components (e.g., filters, energy storage devices, limiters and the like) not described in the example of FIG. 2 can also be included in the RFID tag 50. Therefore, the RFID tag 50 can be configured in any of a variety of ways.

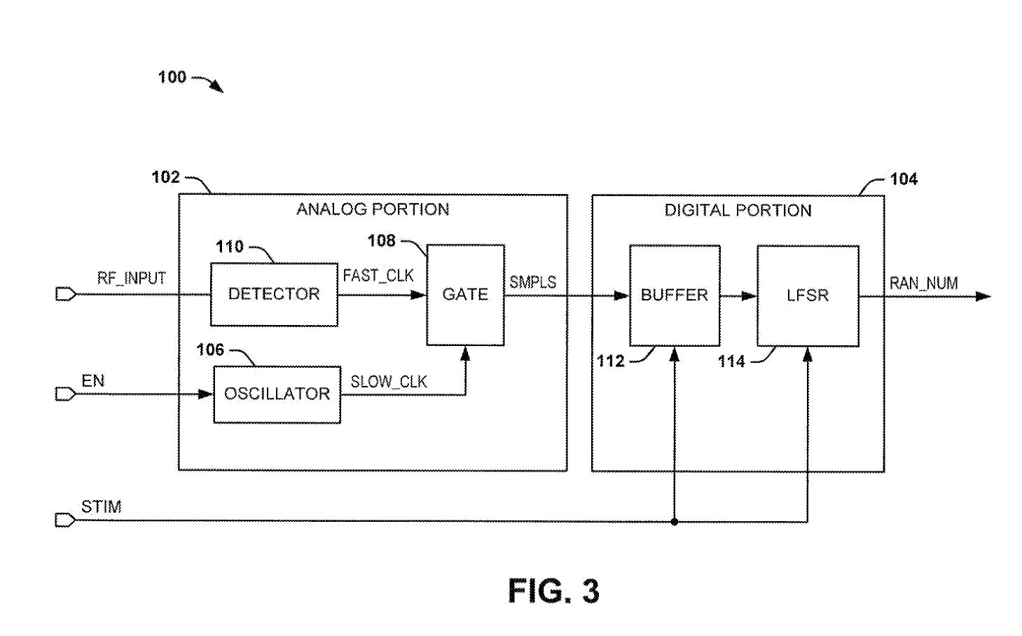

FIG. 3 illustrates an example of a PRNG 100 in accordance with an aspect of the invention. The PRNG 100 can be implemented as the PRNG 30 and/or the PRNG 64 in the examples of FIGS. 1 and 2, respectively. Therefore, reference can be to be made to the examples of FIGS. 1 and 2 for additional contextual information about how the PRNG functions in an RFID system.

The PRNG 100 includes an analog portion 102 and a digital portion 104. The analog portion 102 includes an oscillator 106 and a gate 108. The oscillator 106 is activated based on an enable signal EN. As an example, the enable signal EN can be provided from the logic component 58, or can be directly coupled to the power storage device, such that it is asserted to activate the oscillator 106 in response to the RFID tag 50 being provided with power (e.g., from an RFID interrogation signal). The gate 108 can be configured as any of a variety of data capture or sampling devices. For example, the gate 108 can be configured as a latch or a flip-flop.

The oscillator 106, upon being activated by the enable signal EN, is configured to provide a clock signal SLOW_CLK to the gate 108. A detector 110 may also be included as part of the analog portion 102. Alternatively, the detector 110 may be implemented as part of an AFE of an RFID tag incorporating the PRNG 100. The detector 110 provides an analog fast clock signal (FAST_CLK) to the oscillator, which can be generated or derived from an RF signal, such as an RFID interrogation signal. As an example, the clock signal FAST_CLK can be a high-frequency (e.g., approximately 900 MHz) signal that is provided from the detector 110, thus having a frequency corresponding to the RFID interrogation signal that is provided from an RFID reader (e.g., the reader 12 of FIG. 1). The gate 108 is therefore configured to sample the clock signal FAST_CLK at each cycle of the clock signal SLOW_CLK to generate digital samples SMPLS of the clock signal FAST_CLK. The oscillator 106 can be intentionally configured as substantially unstable, such that the clock signal SLOW_CLK can be provided at an imprecise frequency that is substantially less than the clock signal FAST_CLK (e.g., 400 KHz). As a result, the digital samples SMPLS can be generated in a more random manner, and the oscillator 106 can be more inexpensive to reduce an overall cost of the PRNG 100.

The gate 108 can be configured to provide the digital samples SMPLS at a desired resolution. For example, the clock signal FAST_CLK can be sampled at a resolution of three bits per cycle of the clock signal SLOW_CLK. The digital samples SMPLS are provided to a buffer 112 in the digital portion 104. The buffer 112 can be configured as a shift register having a width that is commensurate with the number of bits of the digital samples SMPLS. For example, for three-bit digital samples SMPLS of the clock signal FAST_CLK, the buffer 112 can be configured as a three-bit shift register. The digital samples SMPLS stored in the buffer 112 can thus be shifted into an LFSR 114 that is likewise included in the digital portion 104. For example, the buffer 112 can be shift the digital samples SMPLS serially into the LFSR 114 in response to a stimulus signal STIM. As an example, the stimulus signal STIM can be provided from the logic component 58, and can also be provided to shift bits through the LFSR 114. As another example, the buffer 112 can be shifted by a separate signal, which could have a frequency that differs from the stimulus signal STIM. Furthermore, it is to be understood that the buffer 112 is not limited to serially loading the digital samples SMPLS into the LFSR 114. As an example, the buffer 112 can load the LFSR 114 with more than one bit at a time (e.g., three bits at a time shifted in parallel), and/or the bits can be provided via one or more logic gates to provide further variation of the digital samples SMPLS that are provided to the LFSR 114.

Based on the operation of the analog portion 102 in generating the pseudorandom digital samples SMPLS, the analog portion 102 is thus configured to generate a pseudorandom number that is provided as a seed to the LFSR 114 in the digital portion 104. The LFSR 114 is thus configured to generate a resultant pseudorandom number RAN_NUM from the seed. As an example, the LFSR 114 can include any of a variety of combinations of feedback gates, such as XOR gates, located in various numbers at various bit locations in the LFSR 114. The pseudorandom number RAN_NUM is thus output from the PRNG 100 to the logic component 58, such that it can be transmitted in the RF response signal.

Based on the operation of both the analog portion 102 in generating a pseudorandom number seed and the digital portion 104 in generating a resultant pseudorandom number RAN_NUM from the seed, the PRNG 100 eliminates the need to inject a seed at manufacture or the need for storing a seed in a dedicated EEPROM. Accordingly, the PRNG 100 provides the benefit of die size reduction and reduced manufacturing costs. Additionally, the PRNG 100 provides the combined benefits of analog and digital pseudorandom number generation. Specifically, the PRNG 100 benefits from low-predictability based on the analog portion 102 and low-power consumption based on the digital portion 104.

It is to be understood that the PRNG 100 is not limited to the example of FIG. 3. As an example, the gate 108 can be configured to provide single-bit digital samples SMPLS, such that the buffer 112 may not be necessary in the digital portion 104, as the single-bit samples SMPLS can be shifted directly into the LFSR 114. As another example, the clock signal SLOW_CLK can be provided from a source other than the oscillator 106, such as based on a signal generated elsewhere within the RFID tag 50. As yet another example, the buffer 112 can have a width that is substantially the same as the LFSR 114, such that the entire pseudorandom number seed can be generated before being provided to (e.g., moved or shifted to) the LFSR 114. Furthermore, the analog portion 102 and the digital portion 104 are not limited to generating pseudorandom numbers based, respectively, on gating the clock signal FAST_CLK and the LFSR 114, but could instead implement any of a variety of other types of pseudorandom number generation. Those skilled in the art will understand and appreciate other ways that the PRNG 100 can be configured based on the teachings contained herein.

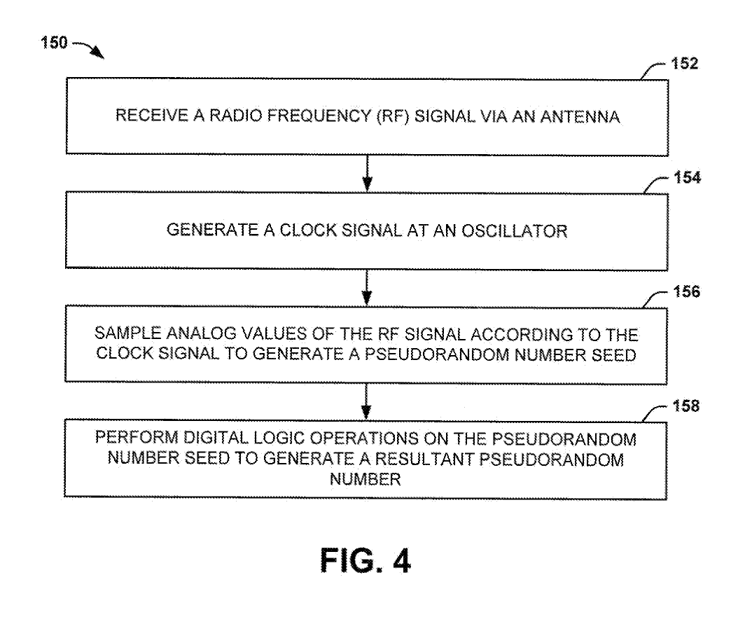

In view of the foregoing structural and functional features described above, certain methods will be better appreciated with reference to FIG. 4. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., analog or digital circuitry, such as may be embodied in an application specific integrated circuit), software (e.g., as executable instructions stored in memory), or any combination of hardware and software.

FIG. 4 illustrates an example of a method 150 for generating a pseudorandom number in accordance with an aspect of the invention. At 152, an RF signal is received at an antenna. The RF signal can be an RFID interrogation signal that is transmitted from an RFID reader. The antenna can be an antenna on a passive RFID tag. At 154, a clock signal is generated by an oscillator. The oscillator can be configured as an unstable oscillator to provide the clock signal at a substantially slow, imprecise frequency (e.g., 400 KHz).

At 156, analog values of the RF signal are sampled at each cycle of the clock signal to generate a pseudorandom number seed. The sampling can be accomplished via a gate structure, such as a latch or flip-flop, having a predefined resolution (e.g., fixed number of one or more bits). For multi-bit resolution, the resultant digital samples can be stored in a buffer, such as a shift register with a width commensurate with the resolution. The pseudorandom number seed can include more than one consecutive digital sample. At 158, digital logic operations are performed on the pseudorandom number seed to generate a resultant pseudorandom number. The digital logic operations can result from the shifting operation of an LFSR. As such, the pseudorandom number seed can be moved into the LFSR all at once, or can be gradually shifted into the LFSR, such that the resultant pseudorandom number is generated as the pseudorandom number seed is shifted into the LFSR.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A pseudorandom number generator (PRNG) for a radio frequency identification (RFID) tag, the PRNG comprising:
an analog portion configured to generate a pseudorandom number seed having a value that varies based on sampling a received RF signal; and
a digital portion configured to generate a pseudorandom number based on the pseudorandom number seed generated by the analog portion.

2. The PRNG of claim 1, wherein the received RF signal is an RFID interrogation signal transmitted from an RFID reader.

3. The PRNG of claim 2, further comprising an analog signal detector that generates a first clock signal in response to the RFID interrogation signal, the first clock signal having frequency that is greater than a sampling frequency employed by the analog portion to sample the first clock signal and to generate the pseudorandom number seed.

4. The PRNG of claim 3, wherein the analog signal detector is part of a demodulator in an analog front-end of the RFID tag, the first clock signal having a clock frequency that is commensurate with a carrier frequency of the RFID interrogation signal.

5. A passive RFID tag comprising the PRNG of claim 3, the passive RFID tag further comprising:
an antenna the receives the RFID interrogation signal;
a demodulator that demodulates the RFID interrogation signal and provides a demodulated RFID interrogation signal to associated logic; and
wherein the analog signal detector comprises a detector separate from the demodulator that provides the first clock signal with a frequency that is commensurate with a carrier frequency of the RFID interrogation signal.

6. The PRNG of claim 1, wherein the analog portion comprises:
an oscillator that provides analog sampling clock signal; and
a gate configured to sample analog values of the received RF signal according to the analog sampling clock signal provided by the oscillator to generate digital samples that define the pseudorandom number seed.

7. The PRNG of claim 6, wherein a frequency of the analog sampling clock signal is substantially less than a frequency of the received RF signal.

8. The PRNG of claim 1, wherein the digital portion further comprises a linear feedback shift register (LFSR) that receives a digital representation of the pseudorandom number seed and is configured to generate the pseudorandom number based on the pseudorandom number seed in response to a shift stimulus.

9. The PRNG of claim 8, wherein the digital portion further comprises a buffer that receives at least one digital sample corresponding to analog values of the received RF signal, the buffer being configured to shift the at least one digital sample the LFSR to generate the pseudorandom number seed.

10. A passive RFID tag comprising the PRNG of claim 1, the passive RFID tag comprising:
an antenna the receives the received RF signal via a wireless link; and
transponder circuitry that generates a response signal that varies based on the pseudorandom number generated by the digital portion of the PRNG.

11. A method of generating pseudorandom numbers within a passive radio frequency identification (RFID) tag, the method comprising:
receiving a radio frequency (RF) signal via an antenna;
providing a first analog clock signal based on detecting analog RF signal corresponding to the received RF signal;
generating a second clock signal by an analog oscillator that is powered in response to the RF signal, the second clock signal having a frequency that is less than a frequency of the first clock signal;
sampling the first clock signal according to the second clock signal to generate a pseudorandom number seed; and
performing digital logic operations on the pseudorandom number seed to generate a pseudorandom number.

12. The method of claim 11, wherein the RF signal comprises receiving an RFID interrogation signal transmitted from an RFID reader.

13. The method of claim 12, further comprising demodulating the RFID interrogation signal via a demodulator of an analog front-end of the RFID tag to generate the first clock signal.

14. The method of claim 11, wherein generating the second clock signal comprises generating the second clock signal at a frequency that is substantially less than a carrier frequency of the received RF signal, the first clock signal having a frequency that is commensurate with the carrier frequency of the received RF signal.

15. The method of claim 11, wherein performing the digital logic operations comprises providing the pseudorandom number seed to a linear feedback shift register (LFSR) that is configured to generate the pseudorandom number from the pseudorandom number seed in response to a shift stimulus.

16. The method of claim 15, further comprising buffering digital samples corresponding to sampled analog values of the first clock signal and serially shifting the buffered digital samples into the LFSR to provide the pseudorandom number seed.

17. A radio frequency identification (RFID) tag comprising:
means for receiving an RFID interrogation signal;
means for generating a pseudorandom number seed having a value that varies based on sampling an analog signal derived from the received RFID interrogation signal; and
means for generating a pseudorandom number by performing digital logic operations on the pseudorandom number seed.

18. The RFID tag of claim 17, wherein the means for generating the pseudorandom number seed further comprises means for sampling the RFID interrogation signal at each cycle of a clock signal, having a frequency that is less that a carrier frequency of the RFID interrogation signal, to generate digital samples corresponding to the pseudorandom number seed.

19. The RFID tag of claim 18, wherein the means for generating the pseudorandom number further comprises means for buffering the digital samples to shift the digital samples serially into the means for generating the pseudorandom number.

20. The RFID tag of claim 17, wherein the means for generating the pseudorandom number seed further comprises means for detecting a carrier frequency of the RFID interrogation signal to generate the analog signal derived from the received RFID interrogation signal.
